(19) United States
(12) Patent Application Publication
(10) Pub. No.: US 2009/0065677 A1
(43) Pub. Date: Mar. 12, 2009

(54) PORTABLE MOLDING APPARATUS AND METHOD FOR CONSTRUCTING PRE-CAST STRUCTURES

(76) Inventor: William Randall Hoff, Las Vegas, NV (US)

Correspondence Address: Jay M. Schloff;Intellipex PLLC, Suite 245, 30200 Telegrahp Road, Bingham Farms, MI, 48025, US

(21) Appl. No.: 12/207,608

(22) Filed: Sep. 10, 2008

Related U.S. Application Data
(60) Provisional application No. 60/971,468, filed on Sep. 11, 2007.

(51) Int. Cl. B28B 7/22; E04B 1/04

(52) U.S. Cl. 249/13; 52/745.2

(57) ABSTRACT

Disclosed is a portable molding apparatus for constructing pre-cast structure. The portable molding apparatus comprises a container, a plurality of partition members, at least one retainer, and a plurality of spacing members. The container comprises a floor, and a pair of longitudinal walls vertically extending from the floor for configuring an interior space therebetween. The plurality of partition members is supported on the floor in a spaced apart manner. The at least one retainer is positioned between at least one pair of partition members of the plurality of partition members for configuring at least two sets of partition members. The plurality of spacing members is positioned between partition members of each of the at least two sets of partition members for configuring a plurality of mold cavities therebetween. The plurality of mold cavities is adapted to receive a building material for constructing the pre-cast structures.

### CROSS REFERENCE TO RELATED APPLICATIONS

The present invention claims priority under 35 United States Code, Section 119 on the provisional application numbered 60/971,468 filed on Sep. 11, 2007.

### FIELD OF THE INVENTION

The present invention generally relates to a construction industry, and, more particularly, to a portable molding apparatus for constructing pre-cast structure, such as roof panels, wall panels, and bridge sections, in the vicinity of a construction site of an architectural structure, such as a residential building, a commercial building, and a bridge.

### BACKGROUND OF THE INVENTION

With growing population throughout the world, there has been a corresponding steady increase in the number of architectural structures, such as residential buildings, commercial buildings, and bridges. Building of such architectural structures generally involves utilization of pre-cast structures, such as roof panels, wall panels, bridge sections, box culverts, underground supports, stair systems, concrete retainer walls, fencing, beams, and columns. Typically, such pre-cast structures are manufactured in industries using conventional concrete molding apparatuses.

More often, it has been observed that such industries are located at a remote place, far from a construction site of the architectural structures. Accordingly, the pre-cast structures, produced in the remote industries, need to be transported to the construction site. The pre-cast structures may be transported to the construction site by using various transportation means, such as road and water transportation. The transportation of the pre-cast structures to the construction site may increase the overall cost involved in the building of the architectural structure. Further, the transported pre-cast structures need to be stored in a proper manner for the further use thereof. More specifically, extra storage space and extra labor for handling the transported pre-cast structures may be required, which may further increase the overall cost involved in the building of the architectural structures.

Moreover, the conventional concrete molding apparatuses used in the industry, does not include a standard size that may enable in easy transportation thereof. Specifically, the conventional concrete molding apparatuses are configured to assume bulky configurations. Therefore, transportation of such conventional concrete molding apparatuses to the construction site may be a difficult task.

Accordingly, there exists a need for a portable molding apparatus for constructing pre-cast structures in the vicinity of a construction site of an architectural structure.

### SUMMARY OF THE INVENTION

In view of the forgoing disadvantages inherent in the prior art, the general purpose of the present invention is to provide a portable molding apparatus for constructing pre-cast structures that is configured to include all advantages of the prior art, and to overcome the drawbacks inherent in the prior art.

Accordingly, an object of the present invention is to provide a portable molding apparatus for constructing pre-cast structures, such as roof panels, wall panels, bridge sections, box culverts, underground supports, stair systems, concrete retainer walls, fencing, beams, and columns, in vicinity of a construction site of an architectural structure.

Another object of the present invention is to provide a portable molding apparatus which may be easily transported to a construction site.

Yet another object of the present invention is to provide a portable molding apparatus which enables in lowering an overall cost associated with the building of an architectural structure.

Still another object of the present invention is to provide a method of constructing pre-cast structures.

In light of the above objects, in one aspect of the present invention, a portable molding apparatus for constructing pre-cast structure is disclosed. The portable molding apparatus comprises a container, a plurality of partition members, at least one retainer, and a plurality of spacing members. The container comprises a floor, and a pair of longitudinal walls vertically extending from the floor of the container. The pair of longitudinal walls and the floor configures an interior space therebetween. The plurality of partition members is adapted to be received in the interior space of the container in a spaced apart manner such that the plurality of partition members is supported on the floor of the container. The at least one retainer is adapted to be positioned between at least one pair of partition members of the plurality of partition members for configuring at least two sets of partition members. The plurality of spacing members is adapted to be positioned between partition members of each of the at least two sets of partition members. The plurality of spacing members, the floor of the container, and the partition members configure a plurality of mold cavities therebetween. The at least one retainer enables in maintaining configuration of the plurality of mold cavities. The plurality of mold cavities is adapted to receive a building material for constructing the pre-cast structures.

In another aspect of the present invention, the container of the portable molding apparatus is a shipping-container such that container is configured to have an international container specifications which enables in easy transportation thereof.

In yet another aspect of the present invention, a method of constructing pre-cast structures is disclosed. The method comprises providing a portable molding apparatus comprising a container, a plurality of partition members, at least one retainer, and a plurality of spacing members, positioning the plurality of partition members, positioning the at least one retainer, positioning the plurality of spacing members, adjusting the at least one retainer, and pouring a building material. The container comprises a floor, and a pair of longitudinal walls vertically extending from the floor for configuring an interior space therebetween. The plurality of partition members is positioned in the interior space of the container in a spaced apart manner to be supported on the floor of the container.

The at least one retainer is positioned between at least one pair of partition members of the plurality of partition members for configuring at least two sets of partition members. The plurality of spacing members is positioned between partition members of each of the at least two sets of partition members, such that the plurality of spacing members, the floor of the container, and the partition members configure a plurality of mold cavities therebetween. The at least one retainer is adjusted for maintaining configuration of the plurality of mold cavities. The building material is poured into the plurality of mold cavities. The method further comprises removing the at least one retainer, the plurality of spacing members, and the plurality of partition members from the interior space of the container after a predetermined time thereby exposing the pre cast-structures acquiring a shape of the plurality of mold cavities.

These together with the other aspects of the present invention, along with the various features of novelty that characterize the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates an exploded perspective view of a portable molding apparatus for constructing pre-cast structures, in accordance with an exemplary embodiment of the present invention;

FIG. 2 illustrates a perspective view of a container of the portable molding apparatus, in accordance with an exemplary embodiment of the present invention;

FIG. 3 illustrates an exploded perspective view of a partition member of the portable molding apparatus, in accordance with an exemplary embodiment of the present invention;

FIG. 4 illustrates a perspective view of a retainer of the portable molding apparatus, in accordance with an exemplary embodiment of the present invention;

FIG. 5 illustrates a perspective view of a maneuvering mechanism of the portable molding apparatus, in accordance with an exemplary embodiment of the present invention;

FIG. 6 illustrates an assembled perspective view of the portable molding apparatus of FIG. 1, in accordance with an exemplary embodiment of the present invention; and

FIG. 7 a flow chart illustrating a method for constructing pre-cast structures, in accordance with an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in implementation thereof. It should be emphasized, however, that the present invention is not limited to portable molding apparatus for constructing pre-cast structures, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a portable molding apparatus for constructing pre-cast structures, such as roof panels, wall panels, bridge sections, box culverts, underground supports, stair systems, concrete retainer walls, fencing, beams, and columns. Such pre-cast structures may be utilized in building an architectural structure, such as a residential building, a commercial building, and a bridge. The portable molding apparatus of the present invention enables in constructing pre-cast structures in the vicinity of a construction site of the architectural structures.

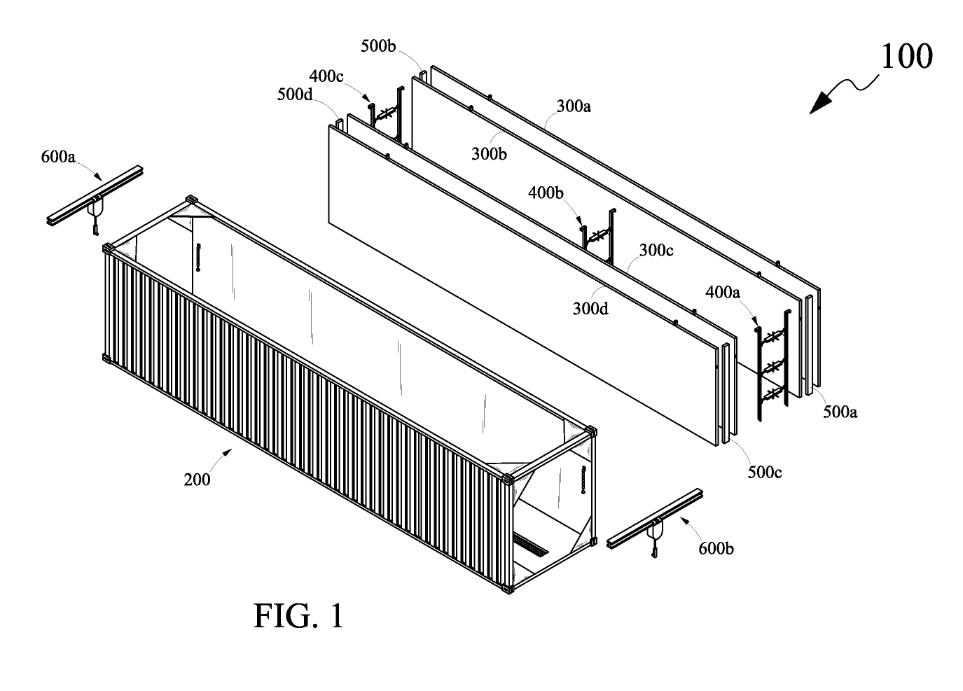

Referring now to FIG. 1, a portable molding apparatus 100 for constructing pre-cast structures is illustrated, in accordance with an exemplary embodiment of the present invention. The portable molding apparatus 100 (hereinafter referred to as apparatus 100) includes a container 200, a plurality of partition members, such as partition members 300a, 300b, 300c and 300d (hereinafter collectively referred as a plurality of partition members 300), at least one retainer, such as retainers 400a, 400b, and 400c (hereinafter collectively referred as retainers 400), and a plurality of spacing members, such as spacing members 500a, 500b, 500c, and 500d (hereinafter collectively referred as to a plurality spacing members 500).

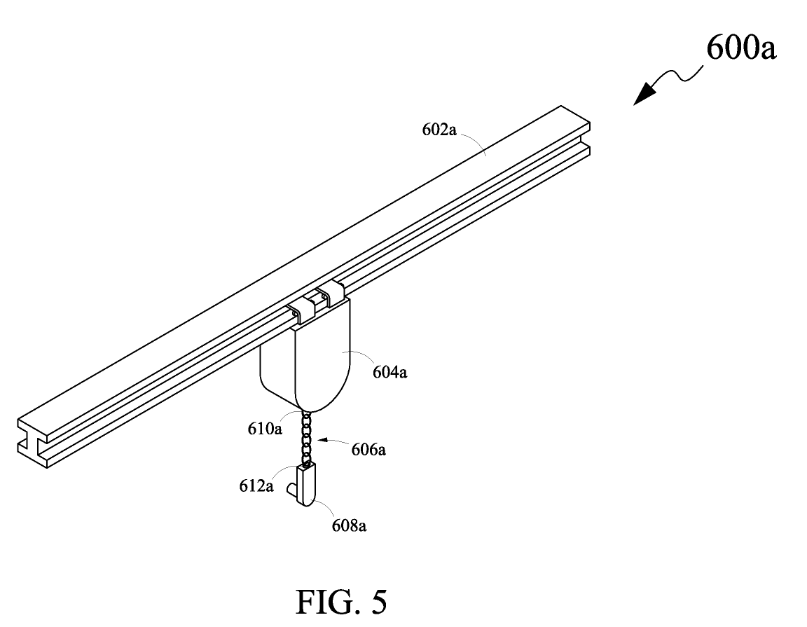

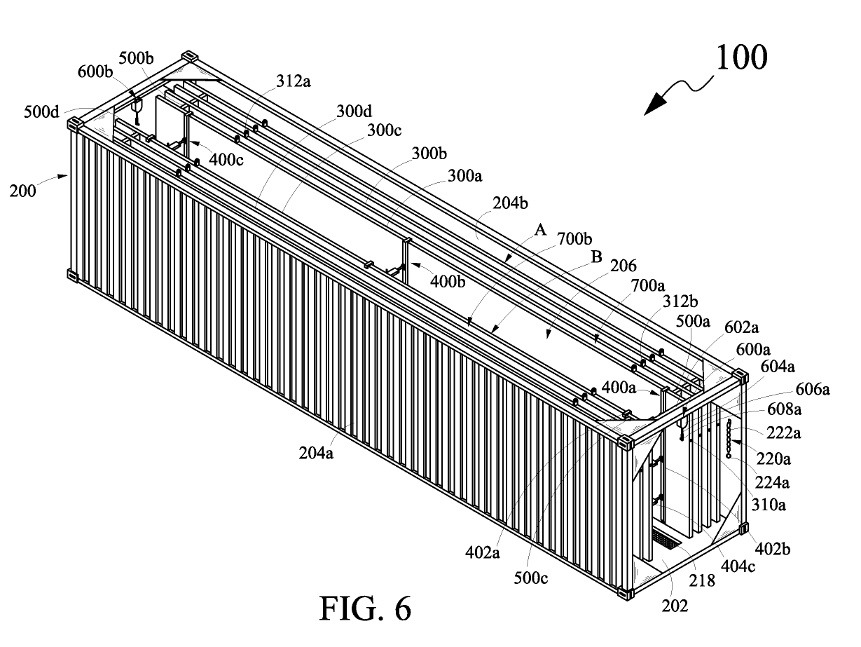

The plurality of partition members 300 is adapted to be received in the container 200. The retainers 400 are adapted to the positioned between at least one pair of partition members of the plurality of partition members 300, received in the container 200, for configuring at least two sets of partition members. The plurality of spacing members 500 is adapted to be positioned between partition members of the at least two sets of partition members of the plurality of partition members 300 for configuring a plurality of mold cavities (not shown). The plurality of mold cavities may be utilized for constructing pre-cast structures. The positioning of the plurality of partition members 300, retainers 400, and the plurality of spacing members 500 in container 200 for configuring the plurality of mold cavities is further explained in detail in conjunction with FIG. 6. The apparatus 100 further includes a pair of maneuvering mechanisms, such as maneuvering mechanisms 600a and 600b (hereinafter collectively referred as maneuvering mechanisms 600) which enables in maneuvering the plurality of partition members 300 within the container 200. The maneuvering mechanisms 600 are further explained in detail in conjunction with FIG. 5.

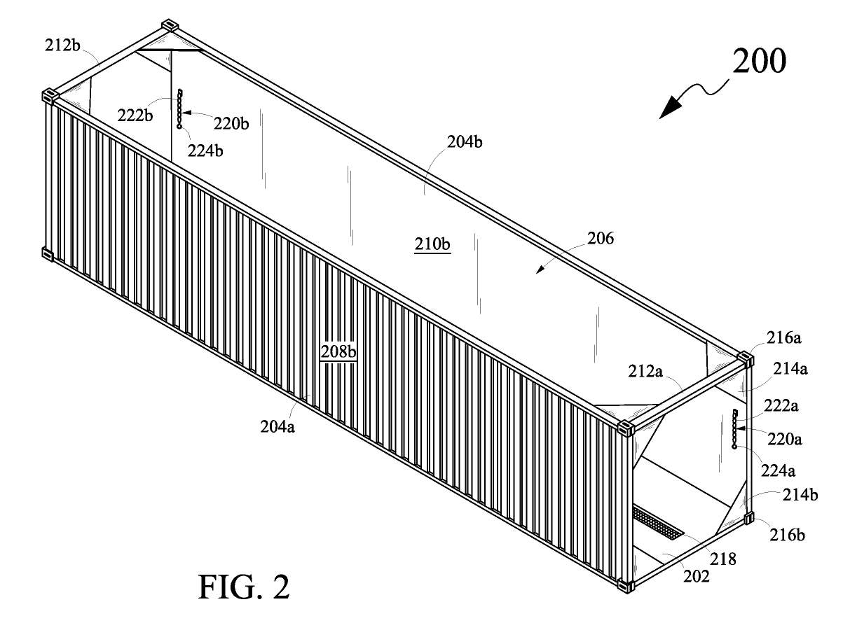

Referring now to FIG. 2, a perspective view of the container 200 of the apparatus 100 is illustrated, in accordance with an exemplary embodiment of the present invention. The container 200 includes a floor 202, and a pair of longitudinal walls, such as longitudinal walls 204a and 204b, vertically extending from the floor 202. Specifically, the longitudinal walls 204a and 204b extend vertically upward from longitudinal edges (not shown) of the floor 202. The longitudinal walls 204a and 204b, and the floor 202 configure an interior space 206 therebetween. The interior space 206 of the container 200 is adapted to receive the plurality of partition members 300 therein. As shown in FIG. 1, the container 200 of the present invention is configured to assume an open top hollow cuboidal structure.

In one embodiment of present invention, the container 200 is a conventional shipping container having international container specifications. More specifically, the conventional shipping container includes longitudinal walls, such as longitudinal walls 204a and 204b, side doors (not shown), a floor, such as the floor 202 and a roof (not shown). Accordingly, in such an instance, the container 200 of the present invention may be configured from the conventional shipping container by removing side doors and the roof of the conventional shipping container. However, it will be evident to a person skilled in the art that the container 200 of the present invention may be configured by arranging any longitudinal walls, such as longitudinal walls 204a and 204b, and any floor, such the floor 202, which may not be, essentially, a part of the conventional shipping container.

As explained herein, the container 200 may be the conventional shipping container. Accordingly, the floor 202 and the longitudinal walls 204a and 204b are configured to assume a rectangular structure. Further, the longitudinal walls 204a and 204b may be configured to have corrugated surfaces, having alternate grooves and ridges configured thereon. More specifically, outer surfaces of the longitudinal walls 204a and 204b may be configured to have a corrugated shape. For example, an outer surface, such as an outer surface 208a of the longitudinal wall 204a may be configured to have the corrugated shape, as shown in FIG. 1. The corrugated outer surfaces of the longitudinal walls 204a and 204b enables in increasing a bending strength of the longitudinal walls 204a and 204b. However, inner surfaces of the longitudinal walls 204a and 204b may be configured to have flat surfaces. For example, an inner surface, such as an inner surface 210b of the longitudinal walls 204b may be configured to have the flat surface, as shown in FIG. 1.

In one embodiment of the present invention, the container 200 may include a pair of support frames, such as support frames 212a and 212b, and a plurality of gusset, such as gussets 214a and 214b. The support frames 212a and 212b extends between opposite top end corners of the longitudinal walls 204a and 204b. The plurality of gussets extends between the support frame 212a and 212b, and the longitudinal walls 204a and 204b. Further, the plurality of gusset also extends between the floor 202 and the longitudinal walls 204a and 204b. For example, the gusset 214a extends between the support frame 212a and the longitudinal wall 204a, whereas the gusset 214b extends between the longitudinal wall 204b and the floor 202. The support frames 212a and 212b, and the plurality of gussets, such as gussets 214a and 214b, enables in strengthening a configuration of the container 200. The container 200 may further include a plurality of corner couplings, such as coupling 216a, and 216b. The plurality of coupling enable in attaching the support frames 212a and 212b with the longitudinal walls 204a and 204b, and attaching the floor 202 with longitudinal walls 204a and 204b. For example, the coupling 216a enables in attaching the support frame 212a with the longitudinal walls 204b, whereas the coupling 216b enables in attaching the floor 202 with the longitudinal walls 204b.

In one embodiment of the present invention, the floor 202 of the container 200 includes a drainage portion 218 configured at a portion of the floor 202. More specifically, the drainage portion 218 is configured centrally along a length of the floor 202. In the present embodiment, the drainage portion 218 is configured on the floor 202 by installing a grating member at the portion of the floor 202. The drainage portion 218 facilitates in cleaning the container 200. In one embodiment of the present invention, the drainage portion 218 may have a width of about 1 foot. Additionally, the floor 202 and the pair of longitudinal walls 204a and 204b may be made of material, such as steel, aluminum, and wood plastic.

The container 200 of the present invention further includes a plurality of supporting arrangements, such as supporting arrangements 220a and 220b, configured on the longitudinal wall 204b. The longitudinal wall 204a also includes supporting arrangements (not shown), such as supporting arrangements 220a and 220b. More specifically, the supporting arrangements, such as the supporting arrangements 220a and 220b, are configured at lateral edges of the longitudinal wall 204a and 204b. The supporting arrangements 220a and 220b includes a support chain and a support hook. For example, the supporting arrangement 220a includes a support chain 222a and a support hook 224a. The support chain 222a is coupled to a lateral edge of the longitudinal wall 204b at a first end of the support chain 222a. The support hook 224a is coupled to the support chain 222a at second end of the support chain 222a. Similarly, the supporting arrangement 220b includes a support chain 222b and a support hook 224b and configured on the longitudinal wall 204b. The supporting arrangements 220a and 220b (hereinafter collectively referred as supporting arrangements 220) enables in supporting the plurality of partition members 300 on the floor 202 of the container 200, which is further explained in conjunction with FIG. 6.

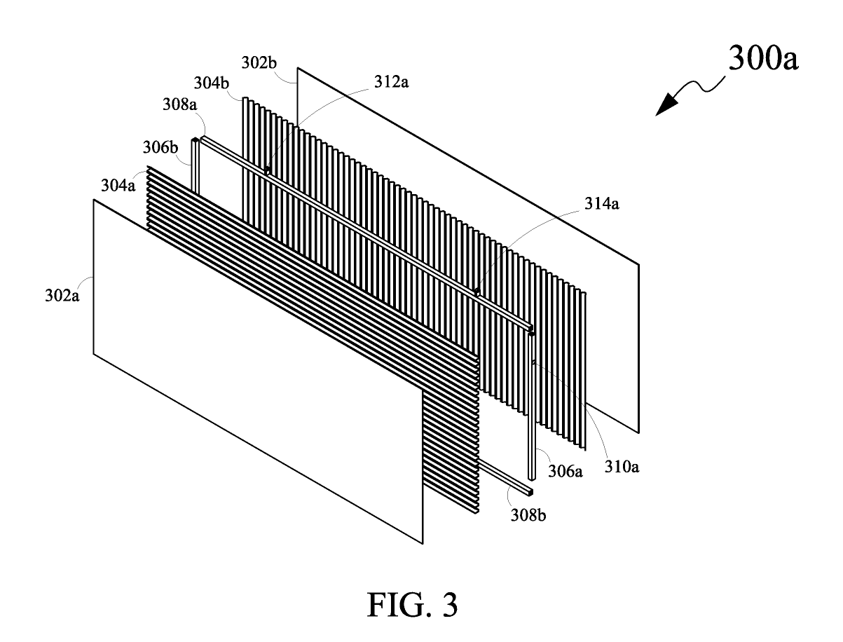

Referring now to FIG. 3, an exploded perspective view of the partition member 300a of the apparatus 100 is illustrated, in accordance with an exemplary embodiment of the present invention. The partition member 300a includes a pair of first sheets, such as first sheets 302a and 302b, a pair of second sheets, such as second sheets 304a and 304b, a pair of lateral frame members, such as lateral frame members 306a and 306b, and a pair of longitudinal frame members, such as longitudinal frame members 308a and 308b.

As shown in FIG. 3, the pair of first sheets 302a and 302b is configured to assume a flat structure, having a plane surface. In one embodiment of the present invention the pair of first sheets 302a and 302b is a galvanized metal sheet having a plane surface. Further, the pair of second sheets 304a and 304b is configured to assume a corrugated structure, having alternate grooves and ridges configured thereon. In one embodiment of the present invention, the pair of second sheets 304a and 304b is a steel sheet having the corrugated structure. However, the second sheet 304a is configured to have a horizontal corrugated structure, whereas the second sheet 304b is configured to have a vertical corrugated structure. The horizontal corrugated structure and vertical corrugated structure of the second sheet 304a and the second sheet 304b, respectively, enables in increasing a bending strength of the partition member 300a. More specifically, horizontal and vertical ridges of the second sheets 304a and 304b, respectively, configure a crisscross pattern, which strengthens the partition members 300a, laterally and longitudinally, after configuration thereof.

For configuring the partition members 300a, the pair of second sheets 304a and 304b is adapted to be disposed between the pair of first sheets 302a and 302b. Thereafter, the pair of lateral frame members 306a and 306b is adapted to be coupled to lateral peripheral edges of the pair of first sheets 302a and 302b. Moreover, the pair of longitudinal frame members 308a and 308b is adapted to be coupled to longitudinal peripheral edges of the pair of first sheets 302a and 302b. The coupling of the pair of lateral frame members 306aand 306b, and the pair of longitudinal frame members 308a and 308b, about the lateral peripheral edges and the longitudinal peripheral edges, respectively, of the pair of first sheets 302a and 302b enables in configuring the partition member 300a. In one embodiment of the present invention, the lateral frame members 306aand 306b, and the longitudinal frame members 308a and 308b are coupled to respective peripheries of the pair of first sheets 302a and 302b by a process of welding.

Further, each lateral frame member of the pair of lateral frame members 306aand 306b includes a locking cavity configured thereon. For example, the lateral frame member 306a is configured with a locking cavity 310a. Similarly, the lateral frame members 306b is also configured with a locking cavity (not shown), such as the locking cavity 310a. The locking cavity, such as the locking cavity 310a, of the lateral frame members 306a and 306b enables in maneuvering the partition member 300a within the interior space 206 of the container 200 with the help of maneuvering mechanisms 600, which is further explained in detail in conjunction with FIGS. 5 and 6.

In one embodiment of the present invention, the longitudinal frame member 308a includes at least one lifting lug, such as lifting lugs 312a and 314a, configured thereon. The lifting lugs 312a and 314a, enables in lifting the partition member 300a out of the interior space 206 of the container 200, which is further explained in detail in conjunction with FIG. 6. In the present embodiment, the lateral frame members 306a and 306b, and the longitudinal frame members 308a and 308b are configured to assume a shape of steel tubing, having hollow square cross section. Such configuration of the plurality of partition members 300 enables in reducing a weight the plurality of partition members 300. Further, it should be understood that the structural configuration and functionality of the partition members 300b, 300c and 300d are similar to the partition member 300a, as described herein. Accordingly, a detailed explanation thereof has been avoided for sake of brevity.

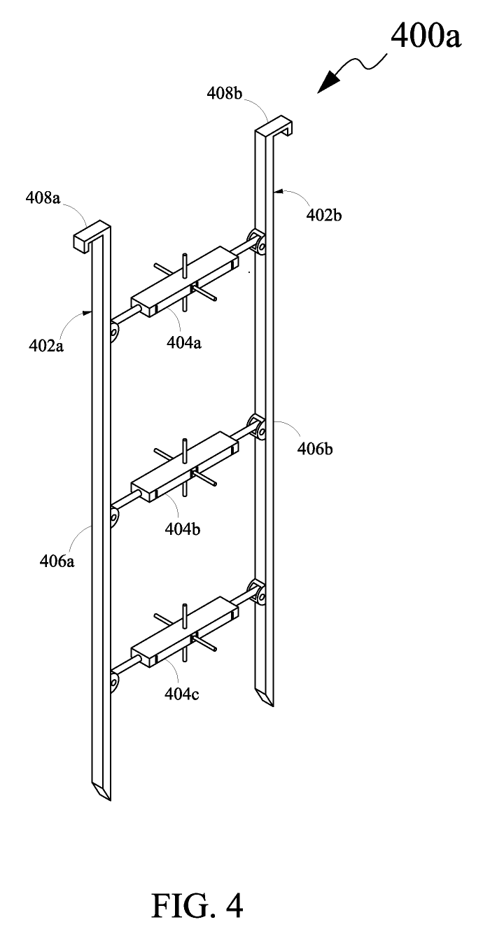

As explained herein, the retainers 400 are adapted to be positioned between the at least one pair of partition members of the plurality of partition members 300 for configuring at least two sets of partition members. Further, the retainers 400 enable supporting the plurality of partition members 300 on the floor 202 of the container 200. Referring now to FIG. 4, a perspective view of the retainer 400a of the apparatus 100 is illustrated, in accordance with an exemplary embodiment of the present invention. The retainer 400a includes a pair of mounting brackets, such as mounting brackets 402a and 402b, and at least one tensioning member, such as tensioning members 404a, 404b and 404c. The tensioning member 404a, 404b and 404c are configured between the pair of mounting brackets 402a and 402b for adjusting a distance between the pair of mounting brackets 402a and 402b.

In one embodiment of the present invention, each of the pair of the mounting brackets 402a and 402b includes an elongated portion and a curved portion configured at an end of the elongated portion. More specifically, the mounting bracket 402a includes an elongated portion 406a and a curved portion 408a configured at an end of the elongated portion 406a. Similarly, the mounting bracket 404b includes an elongated portion 406b and a curved portion 408b configured at an end of the elongated portion 406b.

The tensioning members 404a, 404b and 404c are coupled to the elongated portions 406a, and 406b of the pair of mounting brackets 402a and 402b. The tensioning members 404a, 404b and 404c are capable of spacing apart the pair of mounting brackets 402a and 402b in opposite directions. Further, the tensioning members 404a, 404b and 404c are capable of bringing the pair of mounting brackets 402a and 402b close to each other. In the present embodiment, the tensioning members 404a, 404b and 404c are turnbuckles, capable of moving the pair of mounting brackets 402a and 402b, as described herein. It should be understood that the structural configuration and functionality of the retainers 400b, and 400c are similar to the retainer 400a, as described herein. Accordingly, a detailed explanation thereof has been avoided for sake of brevity.

As explained herein conjunction with FIG. 1, the maneuvering mechanisms 600 enables in maneuvering the plurality of partition members 300 in the interior space 206 of the container 200. The maneuvering mechanisms 600 are configured between the longitudinal walls 204a and 204b of the container 200. Referring now to FIG. 5, a perspective view of the maneuvering mechanism 600a of the apparatus 100 is illustrated, in accordance with an exemplary embodiment of the present invention. The maneuvering mechanism 600a includes a support member 602a, a movable member 604a, a maneuvering chain 606a, and a maneuvering hook 608a. The support member 602a is adapted to extend between opposite top end corners of the pair of longitudinal walls 204a and 204b. More specifically, support member 602a is coupled to the opposite top end corners of the pair of longitudinal walls 204a and 204b and adjacent to the support frame 212a, as shown in FIG. 6. The support members 602a may be coupled to the longitudinal walls 204a and 204b by a process of welding. Further, the coupling of the support member 602a to the longitudinal walls 204a and 204b enables in further strengthening the configuration of the container 200. In one embodiment of the present invention, the support member 602a is configured to assume a shape of an I-beam, as shown in FIG. 5. Further, the I-beams may be made of a steel material.

The movable member 604a is adapted to be slidably coupled to the support member 602a. Specifically, the movable member 604a is capable of slidably moving along a length of the support members 602a between the opposite top end corners of the longitudinal walls 204a and 204b. In one embodiment of the present invention, the movable member 604a is an I-beam trolley. The I-beam trolley may include a motor and a gear arrangement which enables in slidably moving the movable member 604a along the length of the support members 602a.

Further, the maneuvering chain 606ais adapted to be attached to the movable member 604a at a first end 610a of the maneuvering chain 606a. The maneuvering chain 606a is capable of being operated by the movable member 604a. More specifically, a length of the maneuvering chain 606a may be adjusted by the movable member 604a. For example, the maneuvering chain 606a may be rolled and unrolled within the movable member 604a for adjusting the length of the maneuvering chain 606a. In one embodiment of the present invention, the movable member 604a may include a pulley arrangement, operating in conjunction with a motor, for rolling and unrolling the maneuvering chain 606a.

The maneuvering hook 608a is adapted to be attached to the maneuvering chain 606a at a second end 612a of the maneuvering chain 606a. The maneuvering hook 608a is adapted to be revived in the locking cavity 310a (see FIG. 3) of the lateral frame member 306a for enabling in maneuvering the partition members 300a, which is further explained in detail in conjunction with FIG. 6

Referring now to FIG. 6, an assembled perspective view of the portable molding apparatus 100 of FIG. 1 is illustrated, in accordance with an exemplary embodiment of the present invention. The plurality of partition members 300 is received in the interior space 206 of the container 200. More specifically, the plurality of partition members 300 is received in the interior space 206 of the container 200 in a spaced apart manner to be supported on the floor 202 of the container 200. The retainers 400 are positioned between the at least one pair of partition members of the plurality of partition members 300 for configuring at least two sets of partition members, such as a first set of partition members A and a second set of partition members B. More specifically, retainers 400 are positioned between the partition members 300a and 300c for configuring the first set of partition members A and the second set of partition members B. Further, in one embodiment of the present invention the apparatus 100 include three retainers, such as 400a, 400b and 400c. However, it will be evident to person skilled in the art that the retainers 400 may include any suitable number of retainers based on a length of the plurality of partition members 300 to be supported therewith.

Further, as shown in FIG. 6, the first set of partition members A includes the partition members 300a and 300b, and the second set of partition members B includes the partition members 300c and 300d. However, it will be evident to a person skilled in the art that the first set of partition members A and the second set of partition members B may include a multitude of partition members, such as partition members 300a, 300b, 300c and 300d, based on a size of container 200 and a number of per-cast structures needs to be constructed.

The plurality of spacing members 500 is positioned between partition members of each of the first set of partition members A and the second set of partition members B for configuring a plurality of mold cavities. More specifically, the plurality of spacing members 500, the floor 202 of the container 200, and partition members of the first set of partition members A and the second set of partition members B configure the plurality of mold cavities therebetween. For example, the spacing member 500a and 500b is positioned between the partition members 300a and 300b of the first set of partition members A for configuring a mold cavity 700a. Similarly, the spacing member 500c and 500d is positioned between the partition members 300c and 300d of the second set of partition members B for configuring a mold cavity 700b. Accordingly, the plurality of spacing members 500 is adapted to be received between respective partition members of the each of the first set of partition members A and the second set of partition members B, for configuring the plurality of mold cavity, such as mold cavities 700a and 700b, (herein in after collectively referred to as the plurality of mold cavities 700).

Further, the plurality of spacing members 500 may be configured to have various sizes, such that the plurality of spacing members 500 are capable of altering a size of the plurality of mold cavities 700. More specifically, as shown in FIG. 1, the plurality of spacing members 500, such as the spacing members 500a, 500b, 500c, and 500b, are configured to assume an elongated cuboidal structure having a specific width. Accordingly, by altering the width of the plurality of spacing members 500, to be positioned between partition members, the size of the plurality of mold cavities 700 may be altered. The plurality of mold cavities 700 having various sizes may be utilized for constructing different pre-cast structures, such as roof panels, wall panels, bridge sections, box culverts, underground supports, stair systems, concrete retainer walls, fencing, beams, and columns.

After the configuration of the plurality of mold cavities 700, the retainers 400 may be adjusted for retaining the configuration of the plurality of mold cavities 700. For example, the tensioning members 404a, 404b and 404c of the retainers 400a may be rotated for spacing apart the pair of mounting brackets 402a and 402b for pressing the of the first set of partition members A and the second set of partition members B. Similarly, the retainer 400b and 400c may be operated for pressing the of the first set of partition members A and the second set of partition members B, and thereby positioning the plurality of spacing members 500 in an intact manner between the partition members of the first set of partition members A and the second set of partition members B. Further, in one embodiment of the present invention, the plurality of spacing members 500 may be tack welded with the partition members, surrounding the plurality of spacing members 500. The tack welding enables in temporarily coupling the plurality of spacing members 500 with the partition members, surrounding the plurality of spacing members 500. Further, to strengthen the tack welding angle tables (not shown) may be welded with the spacing members 500 and the partition members, surrounding the plurality of spacing members 500.

Once, the plurality of spacing members 500 is coupled between the plurality of partition members 300, a non-stick material, such as oil and grease, may be applied on the plurality of partition members 300. More specifically, surfaces of the plurality of partition members 300 and floor 202, configuring the plurality of mold cavities 700 are applied with the non-stick material. Thereafter, a building material may be poured into the plurality of mold cavities 700. Further, the building material, poured into the plurality of mold cavities 700, may be vibrated to ensure even distribution of the building material within the plurality of mold cavities 700. In one embodiment of the present invention, the building material may include a mixture of sand, cement, gravel, and water.

The building material, poured into the plurality of mold cavities 700, enables in acquiring a shape of the plurality of mold cavities 700. In one embodiment of the present invention, tensioning wires, rebar, or reinforcement steel may be inserted in the plurality of mold cavities 700 before pouring the building material in to the plurality of cavities 700. Insertion of the tensioning wires, rebar, or reinforcement steel enables in reinforcement of the pre-cast structures. Further, in one embodiment of the present invention, elements such as block outs for the windows, doors, basic plumbing, HVAC, electrical fitting, and weld plates that connect the architectural structures may be set in the plurality of mold cavities 700 before pouring the building material in to the plurality of mold cavities 700. Insertion of such elements enables in configuring various cavities in the pre-cast structures for various usages thereof. For example, the block outs for the windows may configure a pre-cast structure with an opening for configuring a window therein. Moreover, in one embodiment of the present invention, the plurality of partition members 300 may be configured with various designs for incorporating the designs on the pre-cast structures. More specifically, a pair of first sheets of each of the plurality of partition members 300 may be configured with various patterns for constructing the pre-cast structures of various designs.

Further, by pouring a measured quantity of the building material into the plurality of mold cavities 700 various pre-cast structures may be constructed. The term “measured quantity” used herein refers to the various quantities of the building material required for constructing various pre-cast structures, such as roof panels, wall panels, bridge sections, box culverts, underground supports, stair systems, concrete retainer walls, fencing, beams, and columns. In such instances, it will be evident to a person skilled in the art that based on the various sizes of the plurality of mold cavities 700 and the measured quantity of the building material various pre-cast structures may be constructed.

Further, the plurality of partitions members 300 is removed from the interior space 206 of the container 200 after a predetermined time. More specifically, the building material is allowed to cure in the plurality of molding cavities 700 and thereafter the plurality of partitions members 300 is removed from the interior space 206 of the container 200. However, it will be evident to a person skilled in the art that before removing the plurality of partitions members 300, the plurality of spacing members 500 and the retainers 400 needs to removed from the container 200. More specifically, the tensioning members 404a, 404b and 404c may be rotated for bringing the pair of mounting brackets 402a and 402b closer to each other and thereby removing the retainers 400 from the container 200. Further, the plurality of spacing members 500 may be removed by breaking the tack welding between the spacing member and the partition members 300.

The plurality of partition members 300 is removed from the interior space 206 of the container 200 with the help of maneuvering mechanism 600 and the plurality of supporting arrangement 220 explained herein conjunction with FIGS. 1 and 4. The plurality of supporting arrangement 220 enables in supporting the plurality of partition members 300 on the floor 202 of the container 200, and the maneuvering mechanism 600 enables in maneuvering the plurality of partition members 300 within the interior space 206 of the container 200. More specifically, maneuvering hooks of the maneuvering mechanisms 600 may be inserted into the locking cavities of a partition member of the plurality of partition members 300 for lifting and separating the partition member. For example, maneuvering hook 608a of the maneuvering mechanism 600a may be received into the locking cavity 310a of the lateral frame member 306aof the partition member 300a. Similarly, a maneuvering hook of the maneuvering mechanisms 600b may be received into the locking cavity of (not shown) of the lateral frame member 306b of the partition member 300a. Thereafter, maneuvering chains of the maneuvering mechanisms 600a and 600b may be rolled with the help of movable members of the maneuvering mechanisms 600a and 600b for lifting the partition members 300a. Further, the movable members of the maneuvering mechanisms 600a and 600b may be slidably moved along support members of the maneuvering mechanisms 600a and 600b for separating the partition member 300a from a pre-cast structure, positioned between the partition member 300a and the partition member 300b.

Further, in such instances, the plurality of supporting arrangement 220 may be used for supporting the plurality of partition members 300 on the floor 202 of the container 200. The plurality of supporting arrangement 220 enables in avoiding the falling of the plurality of partition members 300 while maneuvering the plurality of partition members 300 within the container 200. For example, while lifting and separating the partition member 300a of the first set of partition members A, the partition member 300b may be supported on the floor 202 with the help of supporting arrangements 220a and 220b (see FIG. 2). More specifically, the support hooks 224a and 224b of the supporting arrangements 220a and 220b, respectively, may be inserted into locking cavities of pair of lateral frame members of the partition member 300b. Accordingly, the support chains 222a and 222b coupled to the support hooks 224a and 224b, respectively, holds the partition member 300b on the floor 202. Further, partition members of the first set of partition members A, adjacent to the of the partition member 300b are also supported with the help of supporting arrangements 220a and 220b. Similarly, partition members of the second set of partition members B may be maneuvered by the maneuvering mechanisms 600a and 600b, and supported by the supporting arrangement (not shown), such as supporting arrangement 220a and 220b.

Once, a partitions member is separated from the adjacent partition member, a pre-cast structures (not shown), positioned therebetween may be may be exposed. Thereafter, the pre-cast structures may be lifted from the container 200 by using a lifting device, such as a crane. Further, the plurality of partition members 300 may be also lifted out of the container 200 with the help of the lifting device and lifting lugs configured on longitudinal frame member of the plurality of partition members 300. For example, hooks of the crane may be inserted into the lifting lug 312a and 314a of the longitudinal frame member 308a of the partition member 300a for lifting the partition member 300a out of the container 200. Similarly, remaining partition members of the plurality of partition members 300 may be lifted out of the container 200.

The container 200 may be cleaned after the removal of the plurality of partition members 300 from the container 200. For cleaning the container 200 the drainage portion 218 of the floor 202 may be utilized. More specifically, the longitudinal walls 204a and 204b, and the floor 202 may be washed with the help of a suitable medium, such as water, and thereafter waste water may be allowed to pass through the drainage portion 218 of the floor 202. Further, the plurality of partition members 300, the retainer 400, and the plurality of spacing members 500 may be cleaned for reusing the apparatus 100 for constructing pre-cast structure.

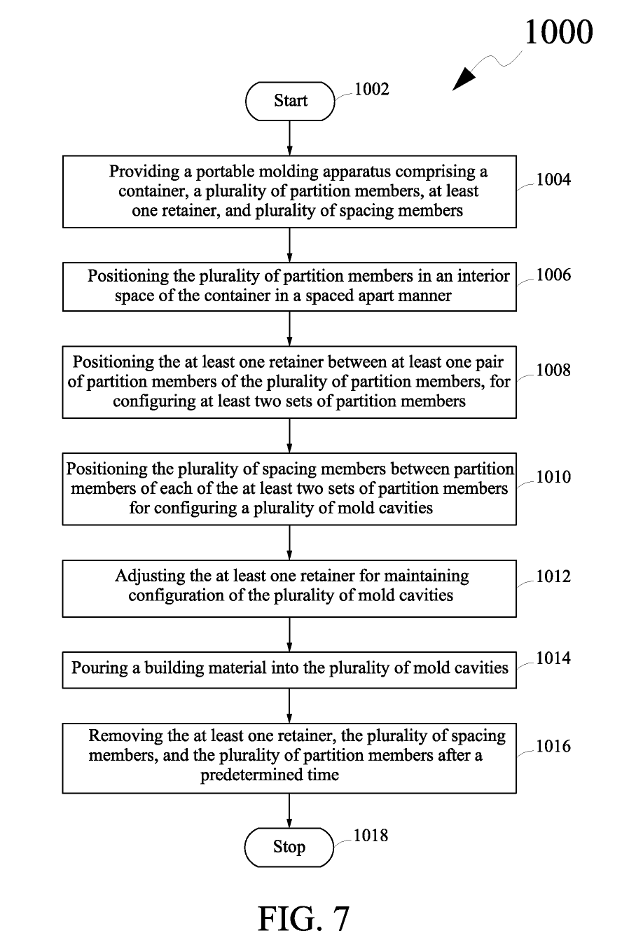

The method of constructing pre-cast structures using the apparatus 100 is explained in conjunction with FIG. 7. Referring now to FIG. 7, a flowchart depicting a method 1000 for constructing the pre-cast structures is illustrated, in accordance with an exemplary embodiment of the present invention. The method for constructing pre-cast structures starts at step 1002. For constructing the pre-cast structures, the portable molding apparatus (hereinafter referred as apparatus 100) having a container, a plurality of partition members, at least one retainer and a plurality of spacing members is provided at step 1004. More specifically, as explained herein conjunction with FIGS. 1 to 6, the portable molding apparatus 100 includes the container, such as the container 200, the plurality of partition members, such as the plurality of partition members 300, the at least one retainer, such as the retainers 400, and the plurality of spacing members, such as the plurality of spacing member 500. Further, the detail explanation of the apparatus 100 has been avoided for sake of brevity. However, it should be understood that method 1000 of the present invention is explained with reference to the apparatus 100 as explained herein conjunction with FIGS. 1 to 6.

The container 200 comprises the floor 202, and a pair of longitudinal walls, such as longitudinal walls 204a and 204b. The longitudinal walls 204a and 204b vertically extending from the floor 202 of the container 200 for configuring an interior space, such as interior space 206 therebetween. The plurality of partition members 300 are adapted to be received in the interior space 206 of the container 200. The plurality of partition members 300 is positioned in the interior space 206 of the container 200 in a spaced apart manner, at step 1006. Further, the plurality of partition members 300 is supported on the floor 202 of the container 200. Thereafter, the retainers 400 are positioned between at least one pair of partition members of the plurality of partition members 300 for configuring at least two sets of partition members, at step 1008. More specifically, the retainers 400 are positioned between the at least one pair of partition members for configuring the first set of partition members A, and the second set of partition members B.

Thereafter, the plurality of spacing members 500 is positioned between partition members of the each of the at least two sets of partition members for configuring a plurality of mold cavities therebetween, at step 1010. More specifically, the plurality of spacing members 500 is positioned between the partition members of the first set of partition members A, and the second set of partition members B for configuring the plurality of mold cavities, such as the plurality of mold cavities 700. The plurality of mold cavities 700 is configured between the floor 202 of the container 200, the partition members of the first set of partition members A, and the second set of partition members B, and the plurality of spacing members 500. The plurality of spacing members 500 is welded to at least one partition member of the first set of partition members A, and the second set of partition members B for positioning the plurality of spacing members 500 in an intact manner. Further, by altering a size of the plurality of spacing members 500 a size of the plurality of mold cavities 700 may be altered, such that the plurality of mold cavities 700 may be utilized for constructing pre-cast structures of various sizes.

The retainers 400 are adjusted for maintaining configuration of the plurality of mold cavities 700, at step 1012. More specifically, retainers 400 may be adjusted by rotating the tensioning members, such as the tensioning members 404a, 404b and 404c, and thereby spacing apart the pair of mounting brackets, such as the mounting brackets 402a and 402b. The spaced apart pair of brackets 402a and 402b enables in pressing the first set of partition members A, and the second set of partition members B, thereby enabling in maintaining the configuration of the plurality of mold cavities 700.

Thereafter, a building material is poured into the configured plurality of mold cavities 700 at step 1014. The building material may be poured by using a concrete pump. Further, the building material poured in the plurality of mold cavities 700, is vibrated by using a concrete vibrator for an even distribution building material thereof. In one embodiment of the present invention, tensioning wires, rebar, or reinforcement steel may be disposed in the plurality of cavities 700 before pouring the building material for enabling in reinforcement of the pre-cast structures.

Thereafter, the retainers 400, the plurality of spacing members 500, and the plurality of partition members 300 is removed after a predetermined time at step 1016. The building material is kept inside the plurality of mold cavities 700 for the predetermined time, such that the building material cures to form pre-cast structures. Specifically, the poured building material acquires a shape of the plurality of mold cavities 700.

The retainers 400, the plurality of spacing members 500, and the plurality of partition members 300 are removed from the interior space 206 of the container 200 consecutively after the predetermined time. Removal of the retainers 400, the plurality of spacing members 500, and the plurality of partition members 300 exposes the pre-cast structures, acquiring the shape of the plurality of mold cavities 700. The retainers 400 may be removed by operating the tensioning members 404a, 404b and 404c for bringing the pair of mounting brackets 402a and 402b, close to each other. Bringing the pair of mounting brackets 402a and 402b close to each other enables in releasing the first set of partition members A and the second set of partition members B.

The plurality of spacing members 500 may be removed by breaking a temporary tack welding between the partition member of the plurality of partitioned members 300 and the plurality of spacing members 500. The plurality of partition members 300 may be maneuvered by maneuvering mechanism, such as the maneuvering mechanism 600a and 600b (hereinafter referred as maneuvering mechanism 600). More specifically, the maneuvering mechanism 600 is operated for lifting and separating the partition member within the interior space 206 of the container 200. Moreover, in an embodiment of the present invention, the partition members of the plurality of partition members 300 may be separated and lifted by holding the lifting lugs, such as lifting lugs 312a and 314a, configured on the longitudinal frame member 308a of the partition member 300a. Specifically, the partition member 300a may be separated and lifted with the help of lifting device, such as a crane. Upon lifting and separating the partition member 300a, a pre-cast structure, positioned between the partition members 300a and 300b, is exposed. The exposed pre-cast structure may be lifted out of the container 200 with the help of a lifting device. Similarly, remaining partition members of the plurality of partition members 300 may be separated and lifted for exposing the pre-cast structures and thereafter lifting the pre-cast structures out of the container 200. Further, the method 1000 from step 1002 to 1016 may be repeated to construct another set of pre-cast structures.

The apparatus, as explained herein conjunction with FIGS. 1 through 7, is capable of being easily transported to a construction site of an architectural structure. More specifically, as explained herein the container is a shipping container having international containers specification. Accordingly, the apparatus of the present invention may be easily transported to a construction site with the help of transportation means, such as road transport and water transport. In one embodiment of the present invention, the container of the apparatus may be configured to have the following dimensions: a length of about 20 feet to 53 feet, and a width of about 2 feet to 9 feet. The portability of the apparatus of the present invention enables in constructing the pre-cast structures, such as roof panels, wall panels, bridge sections, box culverts, underground supports, stair systems, concrete retainer walls, fencing, beams, and columns, in the vicinity of the construction site. Accordingly, a transportation cost and a labor cost associated with the transportation of the pre-cast structures may be avoided, which enables in reducing an over all cost of building the architectural structures.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, and thereby enable others skilled in the art to best utilize the invention and various embodiments with various modifications as are suited to the particular use contemplated. It is understood that various omissions and substitutions of equivalents are contemplated as circumstances may suggest or render expedient, but such are intended to cover the application or implementation without departing from the spirit or scope of the claims of the present invention.

What is claimed is:

1. A portable molding apparatus for constructing pre-cast structures, the portable molding apparatus comprising:
a container comprising a floor, and a pair of longitudinal walls vertically extending from the floor of the container, wherein the pair of longitudinal walls and the floor configure an interior space therebetween;
a plurality of partition members adapted to be received in the interior space of the container in a spaced apart manner to be supported on the floor of the container;
at least one retainer adapted to be positioned between at least one pair of partition members of the plurality of partition members for configuring at least two sets of partition members; and
a plurality of spacing members adapted to be positioned between partition members of each of the at least two sets of partition members,
wherein the plurality of spacing members, the floor of the container, and the partition members configure a plurality of mold cavities therebetween, and
wherein the at least one retainer enables in maintaining configuration of the plurality of mold cavities, and
wherein the plurality of mold cavities is adapted to receive a building material for constructing the pre-cast structures.

2. The portable molding apparatus of claim 1, wherein each partition member of the plurality partition members comprises:
a pair of first sheets;
a pair of second sheets adapted to be disposed between the pair of first sheets;
a pair of lateral frame members adapted to be coupled to lateral peripheral edges of the pair of first sheets; and
a pair of longitudinal frame members adapted to be coupled to longitudinal peripheral edges of the pair of first sheets.

3. The portable molding apparatus of claim 2, wherein each of the pair of lateral frame members comprises a locking cavity configured thereon.

4. The portable molding apparatus of claim 3, wherein the container further comprises a plurality of supporting arrangements configured on the pair of longitudinal walls of the container for supporting the plurality of partition members on the floor of the container.

5. The portable molding apparatus of claim 4, wherein each of the plurality of supporting arrangements comprises:
a support chain coupled to a longitudinal wall of the pair of longitudinal walls; and
a support hook coupled to the support chain,
wherein the support hook is adapted to be received in the locking cavity of a lateral frame member of the pair of lateral frame members, such that the plurality of supporting arrangements enables in supporting the plurality of partition members on the floor of the container.

6. The portable molding apparatus of claim 2, wherein each of the pair of longitudinal frame members comprises at least one lifting lug configured thereon.

7. The portable molding apparatus of claim 3, further comprising a pair of maneuvering mechanisms configured between the pair of longitudinal walls of the container for maneuvering the plurality of partition members within the interior space of container.

8. The portable molding apparatus of claim 7, wherein each of the pair of maneuvering mechanisms comprises:
a support member adapted to extend between opposite top end corners of the pair of the longitudinal walls;
a movable member adapted to be slidably coupled to the support member to move between the opposite top end corners of the pair of the longitudinal walls;
a maneuvering chain adapted to be attached to the movable member at a first end of the maneuvering chain, wherein a length of the maneuvering chain is capable of being adjusted by the movable member; and
a maneuvering hook adapted to be attached to the maneuvering chain at a second end of the maneuvering chain,
wherein the maneuvering hook is adapted to be received in the locking cavity of a lateral frame member of the pair of lateral frame members, such that the pair of maneuvering mechanisms enables in maneuvering the plurality of partition members within the interior space of container.

9. The portable molding apparatus of claim 1, wherein the at least one retainer comprises:
a pair of mounting brackets; and
at least one tensioning member configured between the pair of mounting brackets, the at least one tensioning member capable of adjusting a distance between the pair of mounting brackets.

10. The portable molding apparatus of claim 9, wherein the tensioning member is a turnbuckle.

11. The portable molding apparatus of claim 1, wherein the container further comprises a drainage portion configured at a portion of the floor of the container for enabling in cleaning the container.

12. A method of constructing pre-cast structures, the method comprising:
providing a portable molding apparatus comprising
a container comprising a floor, and a pair of longitudinal walls vertically extending from the floor for configuring an interior space therebetween;
a plurality of partition members,
at least one retainer, and
a plurality of spacing members;
positioning the plurality of partition members in the interior space of the container in a spaced apart manner to be supported on the floor of the container;
positioning the at least one retainer between at least one pair of partition members of the plurality of partition members for configuring at least two sets of partition members;
positioning the plurality of spacing members between partition members of each of the at least two sets of partition members, such that the plurality of spacing members, the floor of the container, and the partition members configure a plurality of mold cavities therebetween;
adjusting the at least one retainer for maintaining configuration of the plurality of mold cavities;
pouring a building material into the plurality of mold cavities; and
removing the at least one retainer, the plurality of spacing members, and the plurality of partition members from the interior space of the container after a predetermined time thereby exposing the pre cast-structures acquiring a shape of the plurality of mold cavities.
